(19) United States
(12) Patent Application Publication
(10) Pub. No.: US 2017/0368799 A1
(43) Pub. Date: Dec. 28, 2017

(54) VACUUM INSULATION PANEL WITH IMPROVED SEALING JOINT

(71) Applicant: SAINT-GOBAIN ISOVER, Courbevoie (FR)

(72) Inventor: Camilla BARBETTA, Paris (FR)

(73) Assignee: SAINT-GOBAIN ISOVER, Courbevoie (FR)

(21) Appl. No.: 15/535,187

(22) PCT Filed: Dec. 14, 2015
(86) PCT No.: PCT/FR2015/053493

§ 371 Date: Jun. 12, 2017

(30) Foreign Application Priority Data
Dec. 23, 2014 (FR) 1463241

(51) Int. Cl. B32B 15/085; B32B 3/26; B32B 3/30; B32B 27/32; B32B 27/08; E04B 1/80; B32B 3/04; B32B 3/06; B32B 15/20

(52) U.S. Cl. CPC B32B 15/085; B32B 3/06; B32B 3/263; B32B 3/30; B32B 15/20; B32B 27/08; E04B 1/803; B32B 3/04; B32B 27/32; B32B 2307/304; B32B 2307/31; B32B 2307/7242; B32B 2419/00; B32B 2607/00; B32B 2250/40

(57) ABSTRACT

A vacuum insulation panel includes two laminate films each having at least a gas barrier layer and a sealant layer, a core material sealed at a reduced pressure between the two laminate films disposed so that the sealant layers may be opposite to each other, and a sealing joint extending from the inner peripheral edge of the two laminate films to an outer peripheral edge defining a joint width, where the sealant layers are fused to each other so as to surround the whole circumference of the core material. The sealing joint has at least one constricted section with a thickness of the fused sealant layers which is lower than the thickness of the non-constricted fused sealant layers extending essentially parallel to the edges. The constricted section/s is/are arranged at the outer peripheral edge and/or at the inner peripheral edge of the two laminate films.

The invention relates to a vacuum insulation panel (VIP) with improved sealing.

Increasing energy costs and energy efficiency regulations are main drivers for improved insulation in the building sector. Besides traditional insulation materials based of foam and fibers, also vacuum insulation panels (VIP-elements) are available for this purpose.

VIP-elements offer a significantly higher insulating property, thus resulting in a lower thickness compared to traditional insulating materials for the same thermal resistance, but this advantage is attended by several well-known drawbacks, such as higher production needs and costs, and vulnerability against mechanical damage.

Generally, a VIP element comprises a core material of a porous material, which is encased by a layer having gas-barrier properties. Usually, a bag element is formed from the encasing material, the hollow space than filled with the core material, air or gases present evacuated to a pressure level below 10⁻³ bar, the bag element finally sealed under vacuum conditions and the product released from the processing vacuum chamber. Typical core materials are Nano-porous materials such as silica powder or the like, or binder-free fiber mats, to avoid a deterioration of the vacuum inside of the VIP element, particularly by decomposition of organic binders.

While VIP-elements have also been proposed with an encasing of stainless steel, these elements have not been successful on the market despite a lower vulnerability against mechanical damage, as the insulating properties are degraded by heat bridging over the lateral faces.

To overcome the heat bridging effect, generally laminate films are meanwhile being used as encaging materials. These laminate films may consist of an innermost layer, which is a sealant layer made of a thermal plastic resin such as a low-density polyethylene or the like. Adhered to the sealant layer is a gas barrier layer made of a barrier material such as metal layer, such as an aluminum foil or aluminum deposition layer. Normally they further comprise a protection cover layer on the outer side exposed to the atmosphere to protect the gas barrier layer against mechanical and/or chemical damage. Two laminate films are disposed so that the sealant layers may be opposite to each other, the sealing layers are fused to each other to form a gas-tight sealing joint by press heating to a temperature above the thermal plastic fusing temperature but below the gas barrier layer and the protection cover layer fusing temperature. Besides such three-layered laminate films, also multi-layer laminates having several gas-barrier layers separated by polymeric layers are available.

Due to the layered structure and the sealing methods applied, a direct contact of (metallic) gas-barriers layers is avoided, and thus the heat bridge is significantly reduced. However, as a consequence of this encasing method, the VIP core is not totally encaged by the gas barrier material, as inevitably there remains a small gas-barrier-layer-free cross section of a certain thickness and of the length of the joint width, which only consists of the sealant material. The size of this cross section, however, is several orders of magnitude lower than the overall surface of the gas-barrier layer of the VIP element.

An essential requirement in building sector is a long service time accompanied by a still acceptable decrease of products properties, which may in insulation be as long as about 30 years. In the case of VIP elements, long service time is directly correlated to the ability of the element to slow down the inevitable increase of internal pressure, i.e. deterioration of the vacuum, due to diffusion of gases and/or vapor into the VIP element. Gases and vapor may penetrate into the VIP either through the membrane, i.e. through the gas-barrier layers or through the sealing joints.

Continuous improvements in the gas-barrier properties of such laminates through the large surfaces have prolonged the service time of VIP elements equipped therewith; thus, despite the size relation of gas-barrier surface and gas-barrier-layer-free cross section, the diffusion into the VIP core through the joint, i.e. through the polymer material filling up the joint, becomes more and more important.

WO2006077599 proposes the addition of a supplemental membrane enveloping the outer edge of the joint. Apart from a difficult adhesion of such supplemental membrane to the joint around the edge requiring a further manufacturing step, the supplemental membrane may increase heat bridging and thus negatively influence VIP thermal performance.

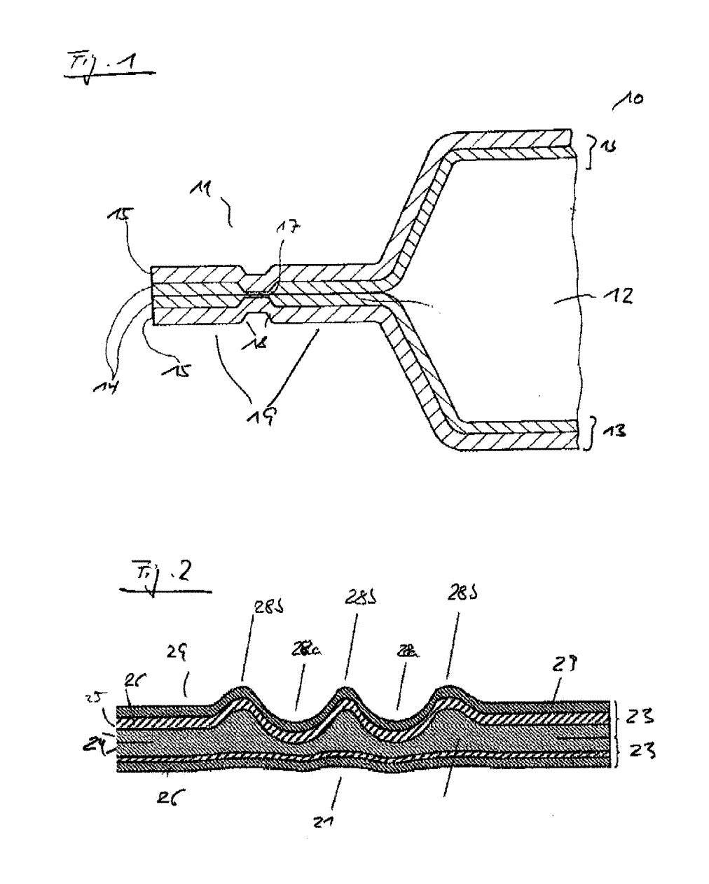

Another measure to enhance joint tightness without adding a further layer is to modify the seal geometry. JP S82-141190U discloses a heat sealed joint with symmetrical constrictions of trapezoidal shape, which are intended to slow down gas diffusion through the polymer matrix of the sealant material into the VIP core, see FIG. 1. The shape of the constriction resp. the design of the sealing jig following pressing conditions and inevitable spreading of the polymer of the constriction zone may create problems with increased wear of the laminate, which may lead to crack formation at the corners of the constriction.

To overcome problems with potential damaging of the gas-barrier layer in the constriction forming process, EP2224159 discloses joints with asymmetrical constrictions and reduced wear of the laminate during processing. The asymmetrical constrictions are formed by a heat fusing and pressing process at the sealing section and comprise several constricted zones, so-called thin-wall parts intermitted by non-constricted zones, so-called thick-wall parts, see FIG. 2. Due to the continuously but smoothly increase and decrease of the thickness of the polymer at the constriction, the constriction may be narrowed in the thin-wall parts without the risk of wear and particularly crack forming. Therefore, of the plurality of thin-wall parts, all sealant layers opposite to each other between two adjacent thin-wall parts are heated and fused, so that a part of the resin for composing the sealant layer in a portion of the adjacent laminate compressed in the thickness direction is moved to the sealant layer in a portion of the adjacent laminate film not compressed in the thickness direction. As a result, the surface of one laminate has a convexo-concave shape, as well as the surface of the other laminate, but both convexo-concave shapes preferably do not oppose each other. The disclosure of EP2224159 is incorporated in this application by explicit reference in its entirety.

EP2224159 compares the atmospheric gas permeability from the sealing part section of the asymmetrical constriction with symmetrical constrictions according to JP S82-141190U for the same laminate and identical thickness of the sealant layer in the thin-wall part and the same number (four) of thin-wall parts. At steady state, gas permeability is identical for both designs, however, the symmetrical design shows a tendency of laminate deterioration.

In exceptional cases for manufacture of small size element, EP2224159 foresees a cut-off of laminate film at the outer circumferential side of the sealing section in such a way, that a thick-wall part forms the new outermost circumferential side, however, as a general teaching the constricted sections are normally arranged in the middle of the joint section width, i.e. in a distance to the inner circumferential side of the joint and in a distance to the outer circumferential side of the joint as in JP S82-141190U.

Given this state of the art, the object of the invention is to provide a VIP element with improved sealing joint design, which further reduces gas diffusion and thus prolongs the service time of the VIP element.

To achieve this object, a vacuum insulation panel according to the invention comprises two laminate films each having at least a gas barrier layer and a sealant layer, a core material sealed at a reduced pressure between the two laminate films disposed so that the sealant layers may be opposite to each other, and a sealing joint extending from the inner peripheral edge of the two laminate films to an outer peripheral edge defining a joint width, where the sealant layers are fused to each other so as to surround the whole circumference of the core material, the sealing joint having at least one constricted section with a thickness of the fused sealant layers which is lower than the thickness of the non-constricted fused sealant layers extending essentially parallel to the edges, whereby the constricted section/s is/are arranged at the outer peripheral edge and/or at the inner peripheral edge of the two laminate films.

Gas permeability through the polymer matrix does include the steps of gas adsorption in the polymer matrix at the gas-barrier-layer-free cross section of the outer peripheral edge oriented to the outer atmosphere, diffusion within the polymer and desorption at the gas-barrier-layer-free cross section of the inner peripheral edge oriented to the VIP core.

While—as already disclosed in the comparison of different constriction design in EP2224159—gas permeability is equal in steady state independently of the specific design as long as overall constriction length of the narrowed thin-wall section and its thickness are equal, the inventors realized that the position of the constriction does have an effect during the transient stage, i.e. during the time needed for gas permeability to obtain steady state.

In a preferred embodiment the thickness of the constricted section/s is 50% or less, especially 25% or less, preferably 15% or less, particularly 10% or less of the thickness of the non-constricted fused sealant layers. The ratio of thickness of the constricted section/s to the thickness of the non-constricted sealant layers is further referred to as constriction ratio.

Preferentially the total length of the constricted section/s is 5% or more, preferably 10% or more, particularly 25% or more of the joint width. The overall length of the constricted sections advantageously reduces the gas permeability and thus the mass flow entering into the VIP core. Although an increase in overall length would reduce gas permeability, the necessary displacement of polymer resin during the heat pressing and fusing induces a certain wear on the laminate, in particular on the gas-barrier layer. In order to minimize said wear during processing, it is preferred that the total length of the constricted section/s is 75% or less, preferably 50% or less, of the joint width.

It is preferred, that the sealing joint comprises further constricted sections. Between two constricted sections there is a non-constricted section. These non-constricted sections may comprise areas of a thickness above the thickness of the sum of the two polymer layers heated and fused due to polymer migration from the constricted section/s into the non-constricted section/s.

In a preferred embodiment according to the invention, the constricted section/s may have an area of constant thickness. In such an embodiment, the transient area from the area of constant thickness of the constricted section to the non-constricted joint section may be concaved in an arc-form or may have a conical form. Alternatively, the area of constant thickness of the constricted section and the non-constricted joint section may also have a ship-lapped form. However, due to increased wear due to sharp edge design of the forming jigs this alternative is less preferred compared to an arc-form or a conical form.

According to an advantageous embodiment of the invention the constricted section has an asymmetric cross section, especially a convexo-concave cross section. The asymmetric cross section design may reduce wear onto the laminate and thus provide processing safety during manufacture by reducing rejection rate. The asymmetric cross section advantageously realizes in-situ several individual constricted zones, the thin-wall parts, spaced apart by non-constricted zones, the thick-wall parts, in one heat and fusing process by an appropriately designed forming jig.

In a preferred embodiment, the laminate films are multi-layer laminates having several gas-barrier layers separated by polymeric layers.

Preferred embodiments of the invention will now be explained by reference to the drawings.

FIG. 1 is a cross section of the sealing joint according to the state-of-the-art disclosed in JP S82-141190U,

FIG. 2 is a cross section detail of the sealing joint according to the state-of-the-art disclosed in EP2224159,

FIG. 3 is a cross section of a first embodiment according to the invention,

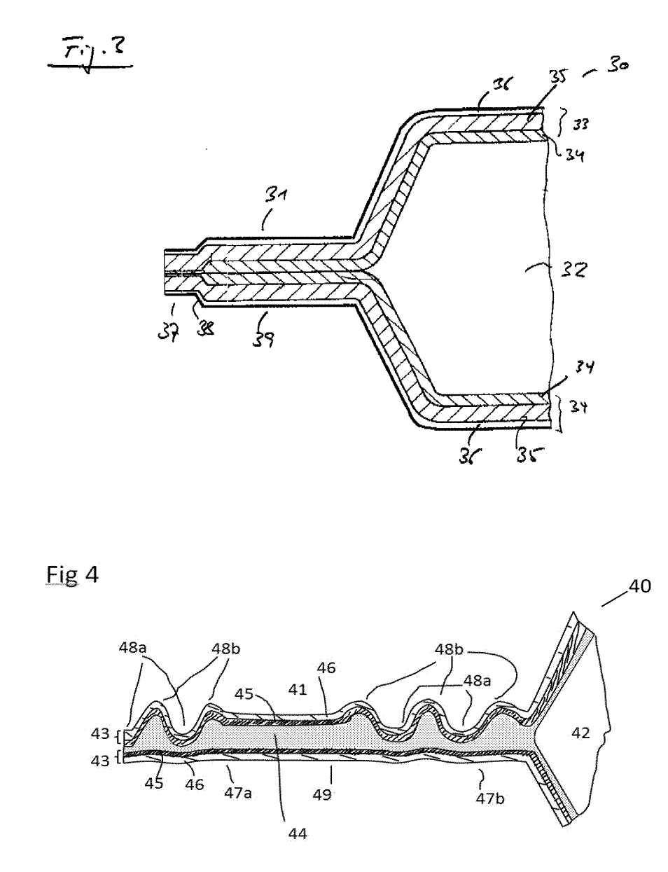

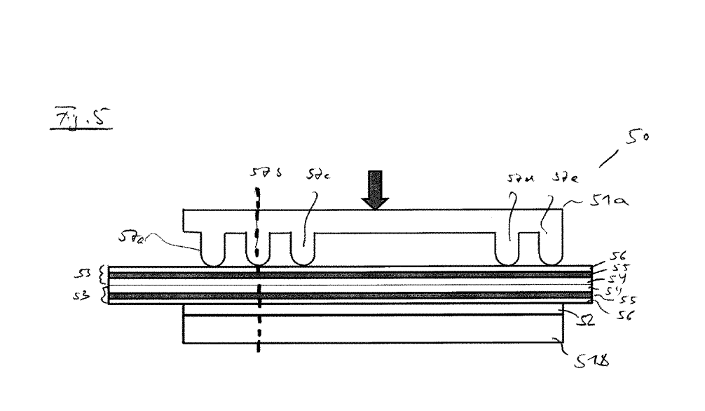

FIG. 4 is a cross section of a second embodiment according to the invention,

FIG. 5 is a forming jig for manufacturing the joint of the second embodiment of the invention according to FIG. 4,

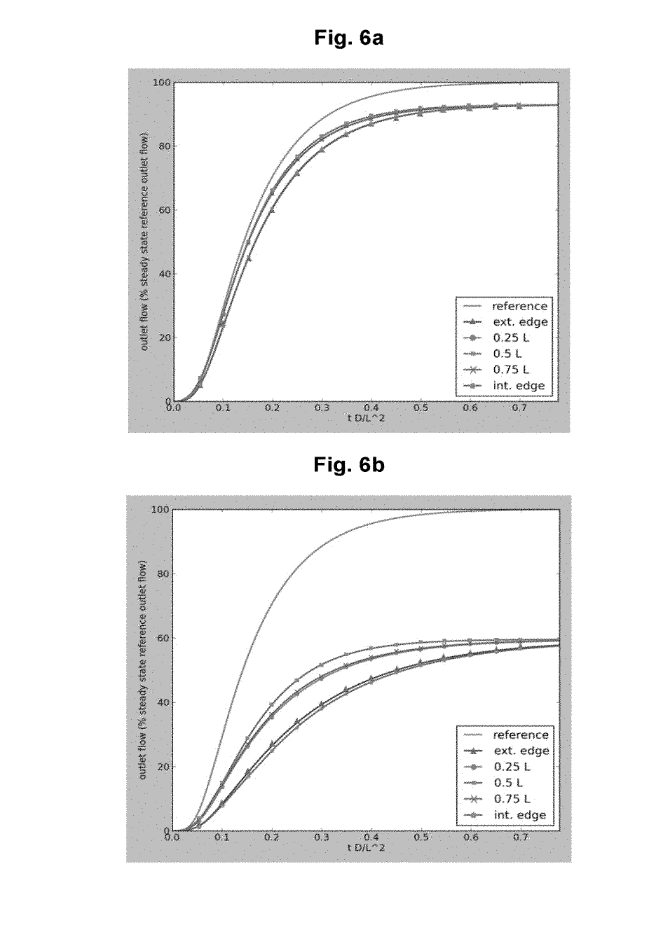

FIG. 6 a, b are two diagrams depicting a normalized mass flow entering into the VIP core for constrictions at different positions in the joint as a function of constriction ratio,

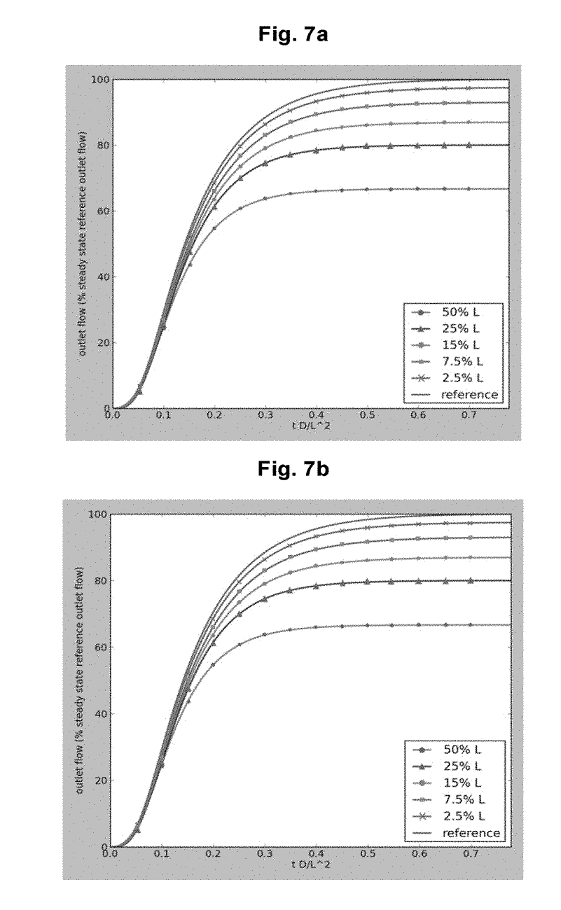

FIG. 7 a, b are two diagrams depicting a normalized mass flow entering into the VIP core for different length of constriction in the joint as a function of constriction ratio,

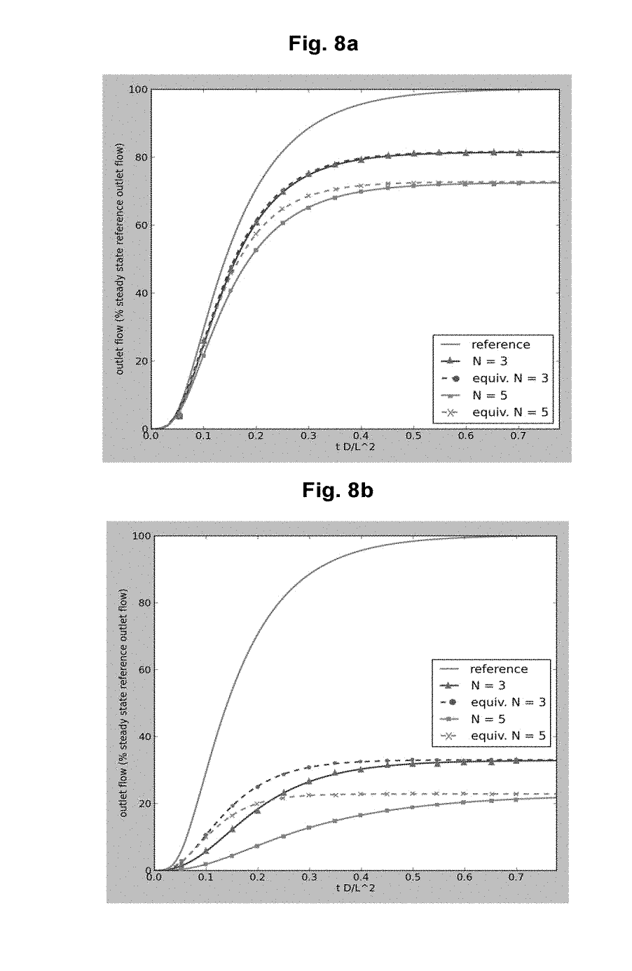

FIG. 8 a, b are two diagrams depicting a normalized mass flow entering into the VIP core for different numbers of constrictions in the joint as a function of constriction ratio.

FIG. 1 depicts a cross section of the sealing joint according to the state-of-the-art disclosed in JP S82-141190U. The vacuum insulating panel 10 comprises a joint section 11, a VIP core 12 filled with a core material (not depicted) and is embedded by two laminates 13, which consist of an a sealant layer 14, whereto a gas barrier layer 15 is adhered to. The two laminate films 13 are disposed so that the sealant layers 14 are opposite to each other, the sealing layers 14 are fused to each other to form a gas-tight sealing joint by press heating to a temperature above fusing temperature of the sealant layer polymer material. In the middle of the joint section 11, there is a constricted section 17 with a transient area 18 extending from the area of constant thickness of the constricted section 17 to the non-constricted joint sections 19 in a conical or trapezoidal form.

FIG. 2 depicts a cross section detail of the sealing joint 21 according to the state-of-the-art disclosed in EP2224159. The cross section detail only shows the sealing joint without extending into the lateral faces of the VIP core. The two laminates 23 embedding the VIP core material (not shown) are arranged as in FIG. 1, and consist of a sealant layer 24, and a gas barrier layer 25. Additionally the laminates further comprises a protection cover layer 26 arranged at the outer side to protect the laminate gas barrier layer 25 against mechanical and/or chemical damage. As in FIG. 1, there is a constricted section 27 arranged in the middle part of the joint section 21, which has an asymmetric cross section of a convexo-concave shape with two thin-wall parts 28a and three thick-wall parts 28b. As can be seen from FIG. 2, the thin-wall parts 28a are lower in thickness compared to the non-constricted joint sections, while the thick-wall parts 28b are higher in thickness as a result of polymer migration during the press forming and fusing.

FIG. 3 shows a first embodiment according to the invention. The vacuum insulating panel 30 comprises a joint section 31, a VIP core 32 filled with a core material (not depicted) and is embedded by two laminates 33, which consist of an a sealant layer 34, a gas barrier layer 35 and a protective cover layer 36. Contrary to the embodiments in the state-of-the-art as shown in FIGS. 1 and 2, the constricted section 37 is not arranged in the middle part of the joint 31, but at the outer peripheral edge of the joint 31, so that the constricted section 37 is in direct contact to the outside atmosphere. The form of the constriction 37 is the same as in FIG. 1, i.e. the area of constant thickness of the constricted section 37 is linked to the area of non-constricted joint 39 by a transient area 38 with a conical shape.

FIG. 4 shows a second embodiment according to the invention. The vacuum insulating panel 40 comprises a joint section 41, a VIP core 42 filled with a core material (not depicted) and is embedded by two laminates 43, with sealant layer 44, gas barrier layer 45 and protective cover layer 46. The joint section 41 has two constricted sections 47a and 47b, whereby the first constricted section 47a is arranged at the outer peripheral edge of the joint (as in the embodiment depicted in FIG. 3). The second constricted section 47b is located at the inner peripheral edge of the two laminate films 43, so that it forms the “border” to the VIP core 42. The non-constricted section 49 is arranged in the middle part of the joint. For reasons of illustration, FIG. 4 is not drawn to scale. Both constricted sections 47a, 47b are of an asymmetric, convexo-concave shape with thin-wall parts 48a and thick-wall parts 48b.

In the embodiments according to the invention (FIGS. 3 and 4), the thickness of the sealant layers 34, 44 is 50 μm, leading to a thickness of the non-constricted joint 39, 49 of 100 μm. The thickness of the constricted sections of constant thickness 37 and the thickness of the thin-wall parts 48a are set to 10 μm, i.e. a constriction ratio of 90%. The width of constriction 37 is about 1 cm, the width of constricted sections 47a, 47b are each set to 10 mm each for a joint welding width of 3 cm. The wider width of constricted sections 47a, 47b is to compensate the thick-wall parts 48b in both constricted sections 47a, 47b.

The VIP core 32, 42 may be filled with any appropriate material known to the expert. Preferred materials are Nano-porous materials such as silica powder or the like, or binder-free fiber mats, particularly binder-free glass wool, to avoid a deterioration of the vacuum inside of the VIP element. Alternatively also fiber mats bound with inorganic binder such as e.g. water glass may be used.

Positioning of a constricted section at the outer peripheral edge of the joint may be achieved rather easily by cutting to size following the press heating and fusing step through a constricted section manufactured with oversize measure. In other words an oversize part of the laminate is removed by cutting inside the constricted section.

Positioning of a constricted section at the inner peripheral edge may be achieved by an appropriately designed forming jig. Such a forming jig is shown in FIG. 5 for heat fusing compressing of a joint according to an embodiment of the invention as shown and described in FIG. 4 above.

Two laminates 53, each with sealant layer 54, gas barrier layer 55 and protective cover layer 56 are placed opposing each other with the sealant layer 54 between the forming jig 50 comprising an upper and a lower heating and compressing jigs 51a, 51b. Onto the lower jig 51b, a silicone rubber sheet 52 is placed which serves as a load distributing element to form the opposite side of the asymmetric convexo-concave shape.

Protrusions 57 are arranged at the lower side of upper heating and compressing jig 51a oriented towards the laminates 53. Note that on the right side with two protrusions 57, the utmost right protrusion 57e is arranged at the outer edge of upper jig 51a, so that the sealant layer right to protrusion 57e is not heated by direct press contact. The right side is oriented, as can been seen in FIG. 4 towards the VIP core 42.

On the left side, i.e. oriented towards the atmosphere, the upper jig 51a has three protrusions 57a, 57b, 57c, further the base section of forming jig 51a as well as lower jig 51b extend over the position of the utmost left protrusion 57a, thus heating the laminates 53 also on the left side of protrusion 57a.

When the heat fusing pressing process is terminated the forming jigs 51a, 51b are removed and the asymmetrical constriction thus formed is cut at the location indicated by dotted line 58 to form a thin-wall part of the constricted section as shown in FIG. 4. Alternatively, forming jigs 51a, 51b might be equipped with an integrated cutting tool to allow cutting without an alignment of the joint resp. the VIP element in a separate cutting apparatus.

It is obvious that a simplified design of the forming jig depicted in FIG. 5 by removing the protrusions 57d, 57e would lead to a design with an asymmetrical constriction only arranged at the outer peripheral edge and vice versa by removing the protrusions 57a, 57b, 57c on the left to a positioning of the asymmetrical constriction at the inner peripheral edge. By replacing the rounded protrusions 57a-e by protrusions of rectangular, or other shape, various joint constriction design, in particular of positioning, length, and compression ratio may be formed. FIGS. 6a and 6b show as result of modeling a normalized mass flow entering into the VIP core for constrictions with a constriction ratio of 50% resp. 90% at different positions in the joint. The calculated mass flow for constrictions at different positions is normalized by the mass flow of the non-constricted reference for the type of constriction—trapezoidal shape—as presented in FIG. 3 and depicted on the ordinate over time normalized by the diffusion coefficient D and the width L of the joint section, in function of the location x in the edge (L being the total width of the edge, a value of linear coordinate x defines the position along the edge axis, x=0 on exterior side of the edge, x=L at the interior side of the edge). One constricted section with a constriction ratio of 50% (FIG. 6a) resp. 90% (FIG. 6b) of the non-constricted thickness is placed at five positions of the joint, namely at the external edge, at 25%, at 50% (in the middle), at 75% of the joint width and at the internal edge.

It can be seen from both FIGS. 6a and 6b, that independently of the position of the constriction, after a certain time, the normalized mass flow achieves the same steady state, which is lower than the non-constricted reference. The mass flow at steady state only depends on the constriction ratio and reduces with higher constriction ratio.

However, during a transient period until the steady stage is reached, the position of the constricted section has a significant influence on the shape of mass flow curves, which show a symmetry which respect to position. A position in the middle of the joint at 50%, leads to a curve with the highest flow, a position at the external or the internal edge yields to a curve with the lowest slope. Positioning the constriction at 25% resp. 75% of the joint width yields to a curve between the two extreme of middle position and inner/outer edge positioning. As the total mass flow into the VIP core corresponds to the integrated (normalized) mass flow over (normalized) time, there is a clear advantage in placing the constriction as near as possible at the edges of the joint, ideally so that the constricted section forms the outer resp. inner cross section towards the atmosphere or towards the VIP core.

FIGS. 7a and 7b show as result of modeling a normalized mass flow entering into the VIP core for one constriction with a constriction ratio of 50% (FIG. 7a) resp. 90% (FIG. 7b) the influence of constriction length. As in FIG. 6, the calculated mass flow for constrictions at different positions is normalized by the mass flow of the non-constricted reference for the type of constriction as presented in FIG. 3 and depicted on the ordinate over time normalized by the diffusion coefficient D and the width L of the joint section. For sake of comparison, constricted sections are arranged at the middle of the joint section, i.e. at a position as illustrated in FIG. 1.

The sensibility to the constriction length is highly dependent on the constriction ratio, the thinner the constriction or the higher the constriction ratio the more effective is increasing its length. It can be seen from FIG. 7a, 7b that steady state is reached earlier the longer the length of the constricted section. However, as the normalized steady state flow rate is significantly lower, there is a clear advantage in extending the length of a constriction.

FIGS. 8a and 8b show as result of modeling a normalized mass flow entering into the VIP core for one constriction with a constriction ratio of 50% (FIG. 8a) resp. 90% (FIG. 8b) the influence of the number of constricted zones. Three resp. five constricted zones of rectangular shape, each extending to 7.5% of the width W of the joint section were centered in the joint width, spaced apart by the same extension of non-constricted zones. For comparison, one constriction with the overall length of the three resp. five constriction zones, i.e. with a length of 22.5% and 37.5% is added to FIG. 8a, 8b.

Besides the improvement during the transient state, FIG. 8a, 8b conform for steady state with the disclosure of EP2224159, which shows in table 1 a decrease of the gas permeability with increased number of constriction zones in the form of asymmetrical thin-wall parts.

As can been seen from FIG. 8a, 8b, multiple constrictions are very efficient to reduce the normalized flow rate during the transient period. Thus, there is a clear advantage to have multiple constrictions compared to one constriction of identical overall length.

As the positioning of the constriction, its (overall) length and the number of constriction zones/thin-wall parts are essentially independent of each other, optimum design and thus long life performance may be achieved by combining all features.

Depending on the width of the joint, the constriction ratio and the diffusion coefficient, the increase in service time of the VIP element according to the invention may be several years to even decades by a thus reduced integral mass flow during the transient state, leading to a lower internal pressure of the VIP when entering steady state of gas permeability.

1: A vacuum insulation panel comprising:
two laminate films each having at least a gas barrier layer and a sealant layer,
a core material sealed at a reduced pressure between the two laminate films disposed so that the sealant layers may be opposite to each other, and
a sealing joint extending from an inner peripheral edge of the two laminate films to an outer peripheral edge defining a joint width, where the sealant layers are fused to each other so as to surround the whole circumference of the core material, the sealing joint having at least one constricted section with a thickness of the fused sealant layers which is lower than the thickness of the non-constricted fused sealant layers extending essentially parallel to the edges,
wherein the constricted section/s is/are arranged at the outer peripheral edge and/or at the inner peripheral edge of the two laminate films.

2: A vacuum insulation panel according to claim 1, wherein a total length of the constricted section/s is 75% or less of the joint width.

3: A vacuum insulation panel according to claim 2, wherein the total length of the constricted section/s is 5% or more of the joint width.

4: A vacuum insulation panel according to claim 1, wherein a thickness of the constricted section/s is 50% or less of the thickness of the non-constricted fused sealant layers.

5: A vacuum insulation panel according to claim 1, wherein the sealing joint comprises further constricted sections.

6: A vacuum insulation panel according to claim 1, wherein the constricted section/s has/have an area of constant thickness.

7: A vacuum insulation panel according to claim 6, wherein a transient area from the area of constant thickness of the constricted section to a non-constricted joint section is concaved in an arc-form or has a conical form.

8: A vacuum insulation panel according to claim 6, wherein the area of constant thickness of the constricted section and a non-constricted joint section have a ship-lapped form.

9: A vacuum insulation panel according to claim 1, wherein the constricted section has an asymmetric cross section.

10: A vacuum insulation panel according to claim 1, wherein the laminate films are multi-layer laminates having several gas-barrier layers separated by polymeric layers.

11: A vacuum insulation panel according to claim 1, wherein a total length of the constricted section/s is 50% or less of the joint width.

12: A vacuum insulation panel according to claim 11, wherein the total length of the constricted section/s is 10% or more of the joint width.

13: A vacuum insulation panel according to claim 11, wherein the total length of the constricted section/s is 25% or more of the joint width.

14: A vacuum insulation panel according to claim 2, wherein the total length of the constricted section/s is 25% or more of the joint width.

15: A vacuum insulation panel according to claim 1, wherein a thickness of the constricted section/s is 10% or less of the thickness of the non-constricted fused sealant layers.

16: A vacuum insulation panel according to claim 1, wherein a thickness of the constricted section/s is 15% or less of the thickness of the non-constricted fused sealant layers.

17: A vacuum insulation panel according to claim 1, wherein a thickness of the constricted section/s is 25% or less of the thickness of the non-constricted fused sealant layers.

18: A vacuum insulation panel according to claim 9, wherein the asymmetric cross section of the constricted section is a convexo-concave cross section.
